(19) United States
(12) Patent Application Publication
(10) Pub. No.: US 2026/0351905 A1
(43) Pub. Date: Nov. 5, 2026

(54) TERMINAL BLOCK

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasuhiro KUDO, Mie (JP); Daisuke HASHIMOTO, Mie (JP); Kentaro TACHI, Mie (JP); Yoshitomo TSUJII, Mie (JP)

(21) Appl. No.: 19/121,129

(22) PCT Filed: Sep. 25, 2023
(86) PCT No.: PCT/JP2023/034619

§ 371 Date: Apr. 15, 2025

(30) Foreign Application Priority Data
Oct. 24, 2022 (JP) 2022-169638

(51) Int. Cl. H01R 13/73

(52) U.S. Cl. CPC H01R 13/73

(57) ABSTRACT

A terminal block to be fixed to an attachment target including a mounting hole includes a terminal including a first end, a second end and a terminal intermediate portion between the first end and the second end, a block body including an inserting portion to be inserted into the mounting hole, the inserting portion being fixed to the attachment target while being inserted in the mounting hole, and a packing to be interposed between the inserting portion and the mounting hole with the block body fixed to the attachment target. The block body holds the terminal while covering the terminal intermediate portion. An outer peripheral surface of the packing includes a tapered outer peripheral surface becoming gradually smaller in an insertion direction into the mounting hole and the tapered outer peripheral surface includes a curved surface convex outward in a cross-section along the insertion direction.

### TECHNICAL FIELD

The present disclosure relates to a terminal block.

### BACKGROUND

Patent Document 1 discloses a terminal block provided with a housing, through which a terminal is inserted in a waterproof manner, an annular packing provided on a surface of the housing facing an object to be attached and an upper cover for pressing the packing against the object to be attached via the housing.

### PRIOR ART DOCUMENT

### Patent Document

Patent Document 1: JP 2010-211933 A

### SUMMARY OF THE INVENTION

### Problems to be Solved

Here, it is desired to enable sealability by the packing to be maintained for a longer period of time. Further, it is desired to obtain good sealability even if the terminal block is inclined around a screw fastened part.

Accordingly, the present disclosure aims to enable sealability by a packing to be maintained for a longer period of time and obtain good sealability even if a terminal block is inclined.

### Means to Solve the Problem

The present disclosure is directed to a terminal block to be fixed to an attachment target including a mounting hole, the terminal block being provided with a terminal including a first end, a second end and a terminal intermediate portion between the first end and the second end, a block body including an inserting portion to be inserted into the mounting hole, the inserting portion being fixed to the attachment target while being inserted in the mounting hole, and a packing to be interposed between the inserting portion and the mounting hole with the block body fixed to the attachment target, the block body holding the terminal while covering the terminal intermediate portion, and an outer peripheral surface of the packing including a tapered outer peripheral surface becoming gradually smaller in an insertion direction into the mounting hole and the tapered outer peripheral surface including a curved surface convex outward in a cross-section along the insertion direction.

### Effect of the Invention

According to the present disclosure, sealability by a packing can be maintained for a longer period of time and good sealability is obtained even if a terminal block is inclined.

### BRIEF DESCRIPTION OF THE DRAWINGS

FIG. 1 is a perspective view of a terminal block and an attachment target according to one embodiment.

FIG. 2 is a perspective view showing the terminal block before being attached to the attachment target.

FIG. 3 is a perspective view showing the terminal block.

FIG. 4 is an exploded perspective view showing the terminal block.

FIG. 5 is a perspective view showing a packing.

FIG. 6 is a section along VI-VI of FIG. 1.

FIG. 7 is a diagram showing a contact state of curved surfaces of the packing and a tapered inner peripheral surface of a mounting hole.

FIG. 8 is a diagram showing the contact state of the curved surfaces of the packing and the tapered inner peripheral surface of the mounting hole in an inclined state of the terminal block.

FIG. 9 is a section showing a terminal block according to a modification.

### DETAILED DESCRIPTION TO EXECUTE THE INVENTION

### Description of Embodiments of Present Disclosure

First, embodiments of the present disclosure are listed and described.

The terminal block of the present disclosure is as follows.
(1) The terminal block to be fixed to an attachment target including a mounting hole is provided with a terminal including a first end, a second end and a terminal intermediate portion between the first end and the second end, a block body including an inserting portion to be inserted into the mounting hole, the inserting portion being fixed to the attachment target while being inserted in the mounting hole, and a packing to be interposed between the inserting portion and the mounting hole with the block body fixed to the attachment target, the block body holding the terminal while covering the terminal intermediate portion, and an outer peripheral surface of the packing including a tapered outer peripheral surface becoming gradually smaller in an insertion direction into the mounting hole and the tapered outer peripheral surface including a curved surface convex outward in a cross-section along the insertion direction.

According to the present disclosure, the outer peripheral surface of the packing includes the tapered outer peripheral surface becoming gradually smaller in the insertion direction into the mounting hole. Thus, if the inserting portion and the packing are inserted into the mounting hole, the packing can be interposed between the inserting portion and the mounting hole while being compressed also in a direction intersecting the insertion direction into the mounting hole. A repulsive force due to this compression can act in the direction intersecting the insertion direction into the mounting hole and be received by the inserting portion and the terminal inside the inserting portion. In this way, the block body hardly undergoes creep deformation and sealability by the packing can be maintained for a longer period of time.

Further, the tapered outer peripheral surface includes the curved surface convex outward in the cross-section along the insertion direction. Thus, even if the terminal block is inclined in a state attached to the attachment target, the curved surface can stably contact the inner peripheral surface of the mounting hole and good sealability is obtained.
(2) In the terminal block of (1), the packing may include a pair of long side portions arranged in parallel at an interval and a pair of short side portions connecting both ends of the pair of long side portions, a length of the packing in an extension direction of the pair of long side portions may be larger than a width of the packing in a connection direction of the pair of long side portions, and the curved surface may be formed on an outward facing surface of each of the pair of long side portions.

If the packing is configured to include the pair of long side portions arranged in parallel at the interval and the pair of short side portions connecting the both ends of the pair of long side portions, there is a possibility that the terminal block is easily inclined around a direction along the pair of long side portions. Accordingly, if the curved surface is formed on the outer peripheral surface of each of the pair of long side portions, the curved surfaces can stably contact the inner peripheral surface of the mounting hole when the terminal block is inclined in an easy direction.
(3) In the terminal block of (1) or (2), the curved surface may include a first curved surface and a second curved surface located on a side opposite to the first curved surface, and the first curved surface and the second curved surface may be located on the same virtual circumference.

If the first curved surface and the second curved surface are located on the same virtual circumference as just described, a contact state of the first and second curved surfaces with the inner peripheral surface of the mounting hole is stabilized when the terminal block is inclined.
(4) In the terminal block of any one of (1) to (3), the curved surface may include a cylindrical part outer peripheral surface having a swing axis of the block body with respect to the attachment target as a center of curvature.

In this way, when the terminal block swings around the swing axis, the cylindrical part outer peripheral surface can stably contact the inner peripheral surface of the mounting hole.
(5) In the terminal block of (4), the center of curvature of the cylindrical part outer peripheral surface may be located on a straight line passing through a first fixing part and a second fixing part to the attachment target.

When the terminal block swings with the straight line passing through a fixing part of a first fixing portion and a fixing part of a second fixing portion, the cylindrical part outer peripheral surface can stably contact the inner peripheral surface of the mounting hole.
(6) In the terminal block of any one of (1) to (5), an outer peripheral surface of the inserting portion may include a pressing tapered outer peripheral surface becoming gradually smaller in the insertion direction.

In this case, the packing is easily compressed in the direction intersecting the insertion direction into the mounting hole by pushing the terminal block into the mounting hole and pressing the pressing tapered outer peripheral surface of the inserting portion against an inner peripheral surface of the packing.
(7) In the terminal block of (6), the outer peripheral surface of the inserting portion may include an end part continuous with a tip side of the pressing tapered outer peripheral surface in the insertion direction and continuously having the same shape along the insertion direction, an inner peripheral surface of the packing may include an outer end part continuously having the same shape along the insertion direction on an outer peripheral side of the end part, and the outer end part of the packing may tighten the end part by a resilient force thereof.

In this way, the packing is easily held in the inserting portion not to be detached.
(8) In the terminal block of any one of (1) to (7), the packing may include a plurality of annular ribs extending along a circumferential direction on an inner peripheral side of the packing and arranged along the insertion direction.

In this case, the packing can be resiliently deformed to crush the plurality of annular ribs with the inserting portion inserted in the insertion hole. In this way, even when manufacturing errors or assembly errors are present, the packing can be set to be sufficiently resiliently deformable.
(9) In the terminal block of (8), the curved surface may be smoother than an inner peripheral surface by the plurality of annular ribs.

In this case, the packing can be largely resiliently deformed by the plurality of annular ribs on the inner periphery of the packing. If the curved surface on the outer periphery of the packing is formed to be smoother than the inner peripheral surface of the packing, the outer periphery of the packing is easily pressed against the inner peripheral surface of the mounting hole in a circumferential direction of the mounting hole even if a partial recess is formed in the inner peripheral surface of the mounting hole. In this way, sealability between the mounting hole and the packing can be improved.
(10) In the terminal block of any one of (1) to (9), the block body may include a fixing portion connected to a base end side of the inserting portion and to be fastened and fixed to the attachment target outside the inserting portion.

If the fixing portion is fastened and fixed to the attachment target, the inserting portion can be held in a state pushed in the mounting hole.

### Details of Embodiment of Present Disclosure

A specific example of a terminal block of the present disclosure is described below with reference to the drawings. Note that the present disclosure is not limited to these illustrations, but is represented by claims and includes all changes in the scope of claims and in the meaning and scope of equivalents.

### Embodiment

Hereinafter, a terminal block according to an embodiment is described.

### Overall Configurations of Terminal Block and Attachment Target

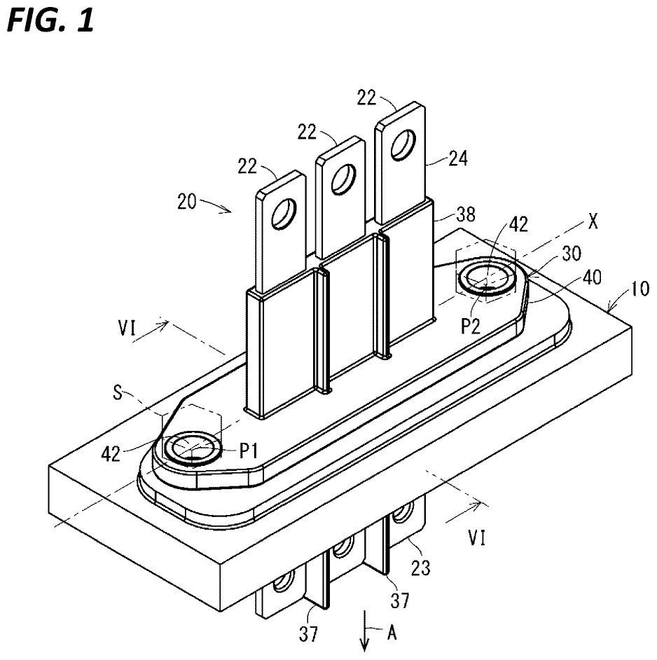

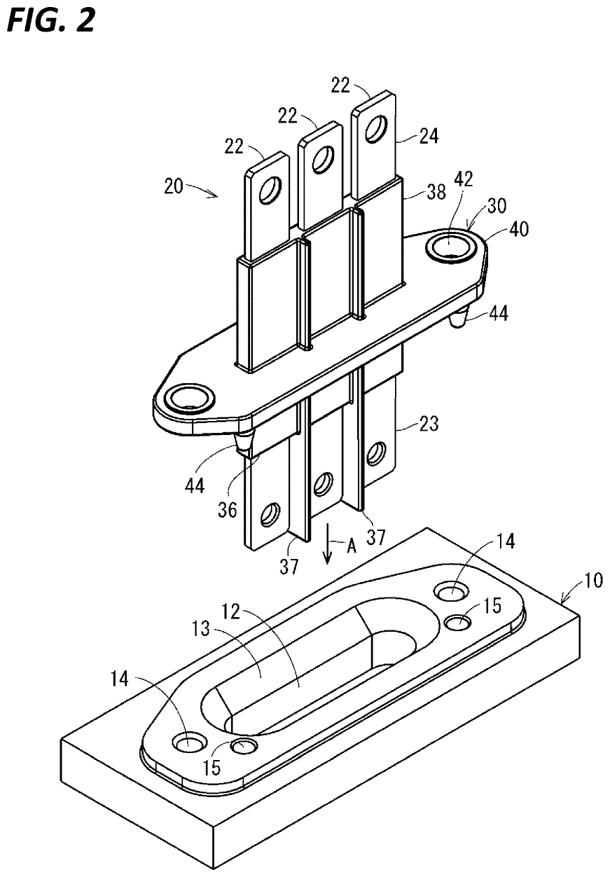

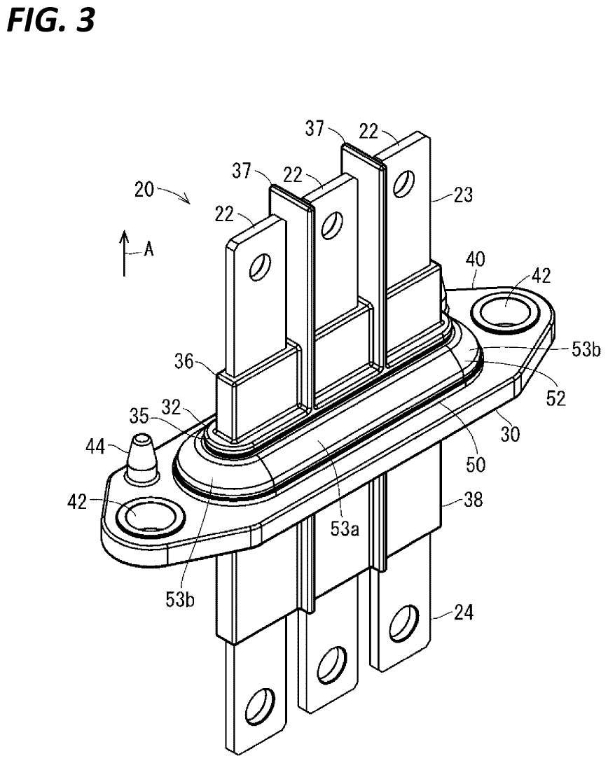

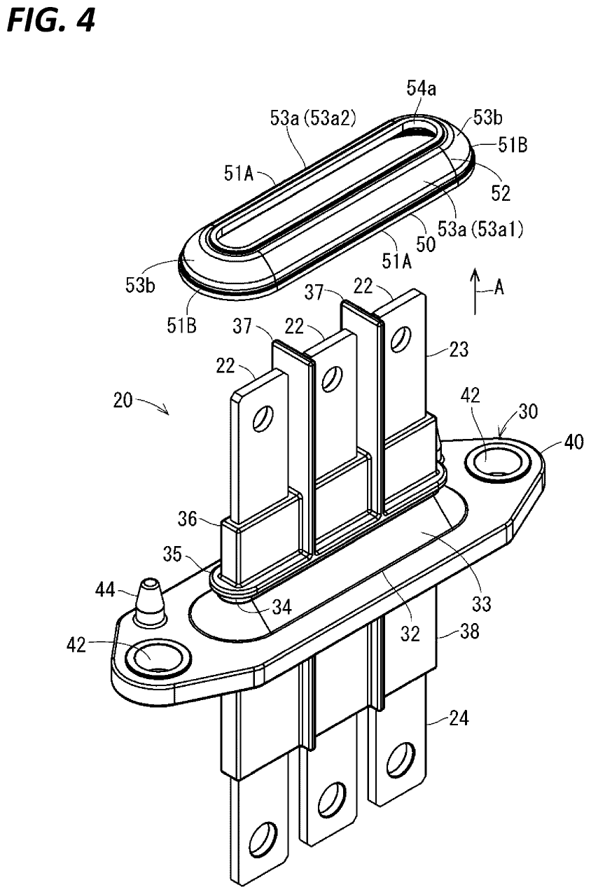

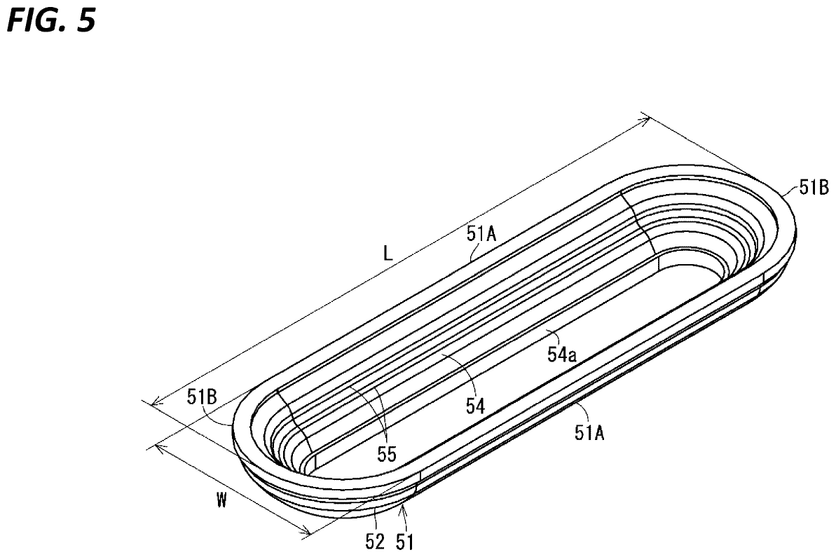

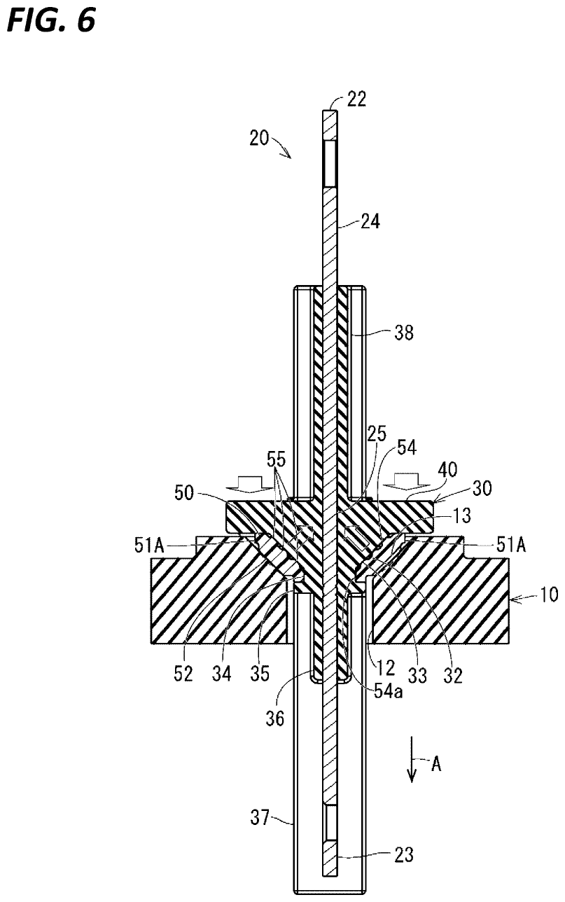

FIG. 1 is a perspective view of a terminal block 20 attached to an attachment target 10. FIG. 2 is a perspective view showing the terminal block 20 before being attached to the attachment target 10. FIG. 3 is a perspective view showing the terminal block 20 and FIG. 4 is an exploded perspective view showing the terminal block 20. FIG. 5 is a perspective view showing a packing 50. FIG. 6 is a section along VI-VI of FIG. 1.

The terminal block 20 is attached to the attachment target 10 including a mounting hole 12. The attachment target 10 is, for example, a part of a case accommodating an electrical component. For example, the case covers the electrical component in a state sealed from an external atmosphere. Thus, it is desired to seal also between the mounting hole 12 and the terminal block 20.

The attachment target 10 is in the form of a plate. The mounting hole 12 is formed to penetrate through the attachment target 10. In this embodiment, the mounting hole 12 is formed into a long hole. The long hole is an elongated oval hole and has, for example, a shape obtained by forming both longitudinal ends of a rectangular shape into a semicircular shape or an elliptical hole shape. An opening on one side of the mounting hole 12 is an insertion-side opening, into which a part of the terminal block 20 is inserted, and an opening on an opposite side is a back-side opening. For example, the insertion-side opening of the mounting hole 12 is an outer opening of the case. The attachment target 10 may be a metal member formed by casting.

The mounting hole 12 includes a part formed into a tapered inner peripheral surface 13 gradually narrowed from the insertion-side opening toward the back-side opening. In this embodiment, a part of the mounting hole 12 near the insertion-side opening is formed into the tapered inner peripheral surface 13, and a part of the mounting hole 12 near the back-side opening is formed to continuously have the same opening shape. The tapered inner peripheral surface 13 may be a part obtained by chamfering the edge of the insertion-side opening of the mounting hole 12.

A pair of screw holes 14 are formed at positions outside the mounting hole 12 in a longitudinal direction in the attachment target 10. Guide holes 15 are formed at positions shifted in a transverse direction of the mounting hole 12 from the positions outside the mounting hole 12 in the longitudinal direction in the attachment target 10.

The terminal block 20 is provided with terminals 22, a block body 30 and a packing 50. With the terminals 22 held by the block body 30, the block body 30 is fixed to the attachment target 10. In this state, the terminals 22 project on both surface sides of the mounting hole 12. An electrical component on one surface side of the attachment target 10 and an electrical component on the other surface side can be electrically connected via the terminals 22. The packing 50 is interposed between the block body 30 and the mounting hole 12. The packing 50 seals a gap between the block body 30 and the mounting hole 12.

### Concerning Terminal Block

The terminal 20 is more specifically described.

The terminal 22 is an electrically conductive member including a first end 23, a second end 24 and a terminal intermediate portion 25 (see FIG. 6) between the first end 23 and the second end 24. The terminal 22 is, for example, constituted by an elongated metal plate member. The terminal intermediate portion 25 is in the form of a rectangular plate. The first end 23 is connected to one end side of the terminal intermediate portion 25, and the second end 24 is connected to the other end part. The first and second ends 23, 24 are formed with holes for fastening and fixing. The terminal may be bent in a thickness direction or a width direction. The terminal may be a component obtained by combining a plurality of components.

In this embodiment, the terminal block 20 is illustrated to include three terminals 22. Without limitation to this example, the number of the terminals provided in the terminal block is arbitrary.

The block body 30 is an insulating member made of resin or the like. The block body 30 includes an inserting portion 32 to be inserted into the mounting hole 12. In this embodiment, the block body 30 is provided with the inserting portion 32, a first terminal holding portion 36, a second terminal holding portion 38 and a fixing portion 40. The block body 30 is, for example, a part integrally molded from the same resin. For example, the block body 30 may be molded with the terminals as inserts.

The inserting portion 32 is a part to be inserted inside the tapered inner peripheral surface 13 of the mounting hole 12. The inserting portion 32 is shaped to become gradually smaller from a base end side toward a tip side in conformity with the tapered shape of the tapered inner peripheral surface 13. With the inserting portion 32 arranged inside the tapered inner peripheral surface 13, an annular space, in which the packing 50 can be arranged, is formed between the inserting portion 32 and the tapered inner peripheral surface 13.

The first terminal holding portion 36 is a part projecting from a tip part of the inserting portion 32. In this embodiment, the first terminal holding portion 36 is formed into a thin rectangular parallelepiped shape. The second terminal holding portion 38 is a part projecting from a base end part of the inserting portion 32. In this embodiment, the second terminal holding portion 38 is formed into a thin rectangular parallelepiped shape. The block body 30 holds the terminals 22 while covering the terminal intermediate portions 25. In this embodiment, the terminal intermediate portion 25 is passed through the second terminal holding portion 38 from the first terminal holding portion 36 through the inserting portion 32. A plurality of the terminal intermediate portions 25 are arranged side by side at intervals in the block body 30. A plurality of the first ends 23 project in parallel from the first terminal holding portion 36. A plurality of the second ends 24 project in parallel from the first terminal holding portion 36. Note that partition walls 37 partitioning between the plurality of first ends 23 extend on a tip part of the first terminal holding portion 36.

The fixing portion 40 is connected to a base end side of the inserting portion 32. The fixing portion 40 is in the form of a plate projecting toward an outer peripheral side from the base end part of the inserting portion 32. In this embodiment, the fixing portion 40 is in the form of an oval plate. The fixing portion 40 is a part fastened and fixed to the attachment target 10 outside the inserting portion 32. In this embodiment, the fixing portion 40 is formed with insertion holes 42. Here, a pair of the insertion holes 42 are formed in both end parts in the longitudinal direction of the fixing portion 40. The pair of insertion holes 42 are formed at positions overlapping the screw holes 14 of the attachment target 10. With the inserting portion 32 inserted in the mounting hole 12, the fixing portion 40 is overlapped on the mounting hole 12. In this state, the insertion holes 42 are arranged outside the screw holes 14. Screws S as fasteners are threadably tightened into the screw holes 14 through the insertion holes 42. In this way, the fixing portion 40 is fastened and fixed to the attachment target 10 outside the inserting portion 32.

In this embodiment, guide pins 44 project on the fixing portion 40. When the inserting portions 32 are inserted into the mounting holes 12, the guide pins 44 are inserted into the guide holes 15. In this way, the block body 30 is guided toward a predetermined designed position with respect to the attachment target 10. Further, the block body 30 is hardly inclined with respect to the mounting hole 12 when the screws S are fastened. The guide pins 44 may be omitted.

With the terminal block 20 fixed to the attachment target 10, the first ends 23 project toward the one surface side (inside the case) of the attachment target 10 and the second ends 24 project toward the other surface side (outside the case) of the attachment target 10. It is assumed that the first ends 23 are connected to the electrical component on the one surface side (inside the case) of the attachment target 10 and the second ends 24 are connected to the electrical component on the other surface side (outside the case) of the attachment target 10. The electrical components may be, for example, electrical wiring members including terminals and the like. For example, the first ends 23 and the second ends 24 are formed with the holes, and the first ends 23 and the second ends 24 are screwed and fixed to the electrical components, utilizing these holes. The first ends 23 and the second ends 24 may be inserted and fixed to the electrical components.

The packing 50 is made of a resilient material such as rubber. The packing 50 is formed into an annular shape to be arrangeable along the annular gap between the inserting portion 32 and the tapered inner peripheral surface 13. With the block body 30 fixed to the attachment target 10, the packing 50 is interposed between the inserting portion 32 and the tapered inner peripheral surface 13 of the mounting hole 12 to close the gap between the inserting portion 32 and the tapered inner peripheral surface 13.

The outer peripheral surface of the packing 50 includes a tapered outer peripheral surface 52 becoming gradually smaller in an insertion direction A into the mounting hole 12. Further, the tapered outer peripheral surface 52 includes curved surfaces 53a, 53b convex outward in a cross-section along the insertion direction A (see FIGS. 3 to 6). In this embodiment, the outer peripheral surface of the inserting portion 32 has a pressing tapered outer peripheral surface 33 becoming gradually smaller in the insertion direction A into the mounting hole 12.

### Concerning Inserting Portion and Packing

The inserting portion 32 and the packing 50 are more specifically described.

The inserting portion 32 projects from a surface of the fixing portion 40 facing the attachment target 10. An outer peripheral part of the inserting portion 32 has the pressing tapered outer peripheral surface 33. A base end part of the pressing tapered outer peripheral surface 33 is formed into an oval shape smaller than the outer opening of the tapered inner peripheral surface 13. A tip part of the pressing tapered outer peripheral surface 33 is formed into an oval shape smaller than the back-side opening of the tapered inner peripheral surface 13. The pressing tapered outer peripheral surface 33 is shaped to become gradually smaller from the base end toward the tip part. With the inserting portion 32 inserted inside the tapered inner peripheral surface 13, a gap having a constant width is formed between the pressing tapered outer peripheral surface 33 and the tapered inner peripheral surface 13. For example, an angle of inclination of the tapered inner peripheral surface 13 with respect to an axial direction of the mounting hole 12 and that of the pressing tapered outer peripheral surface 33 may be equal. A gap gradually narrowed toward a back side may be formed between the pressing tapered outer peripheral surface 33 and the tapered inner peripheral surface 13.

The outer peripheral surface of the inserting portion 32 includes an end part 34 continuous with a tip side of the pressing tapered outer peripheral surface 33 in the insertion direction A and continuously having the same shape along the insertion direction A. That is, the end part 34 is a part extending toward the tip side in the insertion direction A while having the same shape as a tip part of the pressing tapered outer peripheral surface 33.

An annular protrusion 35 is formed which projects toward the outer peripheral side from an end in the insertion direction of the end part 34 A. A projecting dimension of the annular protrusion 35 is set to such a size that the annular protrusion 35 is accommodated in the mounting hole 12.

The packing 50 is formed into an annular shape to be arrangeable on the outer periphery of the inserting portion 32. The outer peripheral surface of the packing 50 includes a tapered outer peripheral surface 52 becoming gradually smaller in the insertion direction A. The inner peripheral surface of the packing 50 includes a tapered inner peripheral surface 54 becoming gradually smaller in the insertion direction A.

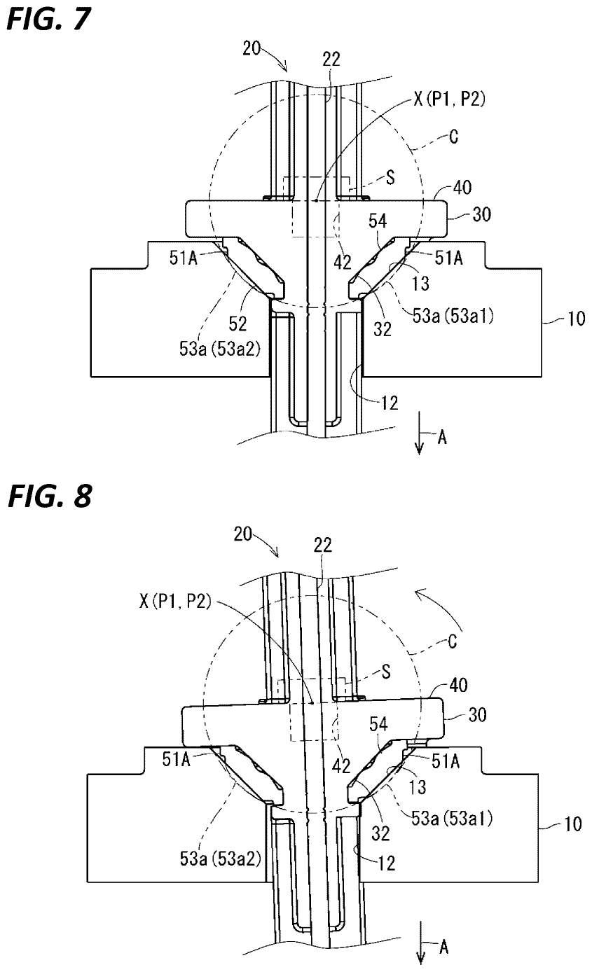

The tapered outer peripheral surface 52 includes the curved surfaces 53a, 53b observable to be convex outward in the cross-section along the insertion direction A. For example, the curved surfaces 53a, 53b are curved to be convex downward to be inclined with respect to the insertion direction A in a cross-section passing through widthwise centers of the terminals 22 and orthogonal to the plate-like terminals 22 (curved surfaces 53a before deformation are shown by two-dot chain lines in FIG. 7).

The curved surfaces 53a, 53b are curved surfaces in a state before the terminal block 20 is fixed to the attachment target 10. With the terminal block 20 fixed to the attachment target 10, the curved surfaces 53a, 53b are pressed against the tapered inner peripheral surface 13. Thus, the outer peripheral surface of the packing 50 is also thought to be a tapered inner peripheral surface, which is resiliently deformed in conformity with the shape of the tapered inner peripheral surface 13 and becomes gradually smaller in the insertion direction A without being curved (see FIG. 6).

The curved surfaces 53a, 53b may be formed over the entire packing 50 in a circumferential direction or may be formed in parts of the packing 50 in the circumferential direction.

In this embodiment, the packing 50 is formed into an elongated shape in conformity with the shape of the inserting portion 32. More specifically, the packing 50 includes a pair of long side portions 51A arranged in parallel at an interval and a pair of short side portions 51B connecting both ends of the pair of long side portions 51A. A length L of the packing 50 in an extension direction of the pair of long side portions 51A is larger than a width W of the packing 50 in a connection direction of the pair of long side portions 51A. Thus, the packing 50 has an annular shape elongated in the extension direction of the long side portions 51A.

The curved surface 53a is preferably formed on the outward facing surface of each of the pair of long side portions 51A. Also, the curved surface 53b is preferably formed on the outward facing surface of each of the pair of short side portions 51B.

The tapered inner peripheral surface 54 includes a plurality of annular ribs 55 extending along a circumferential direction thereof and arranged along the insertion direction A. Note that, if the plurality of annular ribs 55 are formed, as on the tapered inner peripheral surface 54, the annular ribs 55 may be made gradually smaller along the insertion direction A by observing a positional relationship of a group of top parts of the annular ribs 55 or a positional relationship of a group of troughs between the annular ribs 55.

The curved surfaces 53a, 53b on the outer peripheral side of the packing 50 are formed to be smoother than an inner peripheral surface by the plurality of annular ribs 55. Smoothness is evaluated by the magnitude of a radius of curvature. Evaluation may be made such that the larger the radius of curvature, the smoother. For example, in a cross-section of the packing 50 observed by a plane along a center axis of the packing 50, the radius of curvature by the curved surfaces 53a or 53b appearing in this cross-section is larger than that by the annular ribs 55 on the inner peripheral side appearing in this cross-section. The radius of curvature may be that of a top part (i.e. a most projecting part) of a convex shape appearing in the cross-section or may be a maximum value or an average value of the radii of curvature of this convex shape. Further, smoothness may be evaluated by the magnitude of a change amount of irregularities and evaluation may be made such that the smaller the change amount of the irregularities, the smoother. For example, the change amount of the irregularities is one type of line roughness and may be evaluated by an evaluation value, to which an idea of arithmetic average roughness defined by JIS B 0601-2001 is applied. For example, in the cross-section of the packing 50 observed by the plane along the center axis of the packing 50, the idea of arithmetic average roughness may be applied to contour lines of the convex shapes appearing in this cross-section, an average value of absolute values of contour line differences from an average value of contour line heights may be used as an evaluation value and evaluation value may be set such that the smaller this evaluation value, the smoother.

An outer end part 54a is formed which is continuous with a tip side of the tapered inner peripheral surface 54 of the packing 50 in the insertion direction A and continuously has the same shape along the insertion direction A. That is, the outer end part 54a is a part continuous with the tip side in the insertion direction A while having the same shape as the tip part of the tapered inner peripheral surface 54. This outer end part 54a is set to be smaller than the end part 34 of the inserting portion 32. Thus, the outer end part 54a is resiliently stretched with the outer end part 54a arranged round the end part 34. In this case, this outer end part 54a tightens the end part 34 by a resilient force thereof. In this way, the packing 50 is hardly detached from the inserting portion 32.

In this embodiment, the tip part of the packing 50 is in contact with the annular protrusion 35. The annular protrusion 35 also suppresses the detachment of the packing 50 from the inserting portion 32.

With the packing 50 attached to the inserting portion 32, an end part of the packing 50 on the side of the fixing portion 40 is in contact with the fixing portion 40. In this way, if the fixing portion 40 is fixed to be pressed against the attachment target 10, the packing 50 can be pushed into the mounting hole 12 by this pressing force.

### Contact Examples of Curves Surfaces and Shape Examples of Curved Surfaces

FIGS. 7 and 8 are diagrams showing a state where the terminal block 20 is attached to the attachment target 10. The terminals 22 are parallel to a center axis of the mounting hole 12 in FIG. 7, and the terminals 22 are inclined with respect to the center axis of the mounting hole 12 in FIG. 8. In FIGS. 7 and 8, an initial shape of the packing 50, the position of the screw hole 14 and a head part of the screw S are shown by two-dot chain lines.

In a state shown in FIG. 7, top parts bulging most outward, out of the curved surfaces 53a, 53b, are pressed against the tapered inner peripheral surface 13. The parts of the curved surfaces 53a, 53b pressed against the tapered inner peripheral surface 13 are resiliently deformed into a tapered outer peripheral surface shape in conformity with the shape of the tapered inner peripheral surface 13. In a cross-section along the insertion direction A, the parts of the curved surfaces 53a, 53b pressed against the tapered inner peripheral surface 13 are linear.

It is possibly assumed that the terminal block 20 is inclined with respect to the attachment target 10 as shown in FIG. 8. In this case, it is assumed that a part near the fixing portion 40, out of one curved surface (hereinafter, may be distinguished as a first curved surface 53a1), out of the pair of curved surfaces 53a, is pressed against a part near the back, out of the tapered inner peripheral surface 13 (see left side of FIG. 8), and a part near the first end 23, out of the other curved surface (hereinafter, may be distinguished as a second curved surface 53a2) is pressed against a part near the opening, out of the tapered inner peripheral surface 13 (see right side of FIG. 8).

Also in this case, since the curved surfaces 53a are convex outward in the cross-section along the insertion direction A, contact modes of the both curved surfaces 53al, 53a2 with the tapered inner peripheral surface 13 are the same. That is, although contact positions are different, similarly curved parts of the both curved surfaces 53b1, 53a2 are in contact with the tapered inner peripheral surface 13 having the same angle of inclination.

Thus, the curved surfaces 53a1, 53a2 can contact the tapered inner peripheral surface 13 in the same contact mode, regardless of whether or not the terminal block 20 is inclined with respect to the attachment target 10, and the angle of the terminal block 20 with respect to the attachment target 10. For example, the contact positions of the curved surfaces 53a1, 53a2 with the tapered inner peripheral surface 13 are different, but contact widths can be made as equal as possible. In this way, sealability by the packing 50 is stabilized.

Particularly, it is assumed that, if the packing 50 is elongated, the pair of long side portions 51A are more likely to be inclined and vertically shifted in position than the pair of short side portions 51B. Thus, if the curved surfaces 53a1, 53a2 are formed on the pair of long side portions 51A, sealability is effectively maintained even if this inclination occurs.

Of course, if the curved surfaces 53b are formed also on the pair of short side portions 51B, sealability is effectively maintained if the pair of short side portions 51B are inclined and vertically shifted in position.

If the packing 50 has curved surfaces located opposite to each other, those curved surfaces are preferably located on the same virtual circumference C. For example, if the curved surface 53al is formed on one long side portion 51A and the curved surface 53a2 is formed on the other long side portion 51A, the curved surface 53a2 as the second curved surface can be grasped as an example located on a side opposite to the curved surface 53a1 as the first curved surface. That is, the curved surfaces 53a1, 53a2 are preferably curved surfaces having the same center of curvature and the same radius of curvature.

In this case, if the terminal block 20 is inclined, the curved surfaces 53a1, 53a2 are displaced to be inclined by the same angle with respect to the tapered inner peripheral surface 13. Thus, if the curved surfaces 53a1, 53a2 are located on the same virtual circumference C, the curved surfaces 53a1, 53a2 easily contact the tapered inner peripheral surface 13 in the same contact mode with the terminal block 20 inclined.

The curved surfaces 53a1, 53a2 preferably include cylindrical part outer peripheral surfaces having a swing axis X of the block body 30 with respect to the attachment target 10 as a center of curvature. The swing axis X of the block body 30 with respect to the attachment target 10 is, for example, a center of rotation when the block body 30 is inclined into an easily inclined posture from a reference posture in design if the easily inclined posture is assumed due to a fixing structure of the block body 30 to the attachment target 10. The cylindrical part outer peripheral surface is a surface constituting a part of the outer peripheral surface of a circumference.

For example, the centers of curvature of the cylindrical part outer peripheral surfaces of the curved surfaces 53a1, 53a2 may be located on a straight line L passing through a first fixing part P1 and a second fixing part P2 to the attachment target 10 (see FIGS. 1, 8 and 9).

The fixing parts P1, P2 are positions serving as fixing references when the block body 30 is fixed to the attachment target 10. For example, in this embodiment, the screws S are threadably tightened into the screw holes 14 through the insertion holes 42. With the screws S threadably tightened in the screw holes 14, the screws S are located in places to be easily held at fixed positions with respect to the attachment target 10. Further, since the head parts of the screws S press the upper opening edges of the insertion holes 42 downward, the upper opening edges of the insertion holes 42 near the head parts of the screws S are parts easily held at fixed positions with respect to the attachment target 10. Thus, the straight line L passing through centers of the upper opening edges of the two screw holes 14 is grasped as the swing axis, and the centers of curvature of the cylindrical part outer peripheral surfaces of the curved surfaces 53a1, 53a2 may be set on the straight line L.

In this way, the block body 30 can effectively press the curved surfaces 53a against the tapered inner peripheral surface 13 in the easily inclined posture.

The outward facing surfaces of the short side portions 51B may or may not be curved. For example, the outward facing surfaces of the short side portions 51B may be the curved surfaces 53b curved similarly to the curved surfaces 53a.

### Effects, Etc.

The terminal block 20 is attached to the attachment target 10 with the packing 50 attached to the inserting portion 32. That is, the inserting portion 32 and the packing 50 are inserted into the mounting hole 12 with the first ends 23 facing the mounting holes 12. At this time, the packing 50 and the inserting portion 32 are guided to predetermined positions with respect to the tapered inner peripheral surface 13 by inserting the guide pins 44 into the guide holes 15.

If the packing 50 is arranged inside the tapered inner peripheral surface 13, the tapered outer peripheral surface 52 of the packing 50 is pressed against the tapered inner peripheral surface 13 of the mounting hole 12.

The inserting portion 32 is further pushed into the mounting hole 12. For example, the fixing portion 40 is pushed toward the attachment target 10 by threadably tightening the screws S into the screw holes 14 of the attachment target 10 with the screws S inserted through the insertion holes 42 of the fixing portion 40. In this way, the inserting portion 32 connected to the fixing portion 40 is further pushed to the back of the mounting hole 12. Preferably, the fixing portion 40 pushes the packing 50 into the inside of the tapered inner peripheral surface 13 by directly pushing the packing 50.

Here, the outer peripheral surface of the packing 50 is formed into the tapered outer peripheral surface 52 becoming gradually smaller in the insertion direction A. Thus, if the inserting portion 32 and the packing 50 are pushed into the mounting hole 12, an interval between the inserting portion 32 and the mounting hole 12 becomes narrower in the insertion direction A and the packing 50 is compressed along the insertion direction A. Further, also in a direction intersecting the insertion direction A, the interval between the inserting portion 32 and the mounting hole 12 becomes narrower and the packing 50 is compressed in this direction. Thus, the packing 50 can be interposed between the inserting portion 32 and the mounting hole 12 while being compressed in the insertion direction A and the direction intersecting the insertion direction A. A gap between the tapered inner peripheral surface 13 and the tapered outer peripheral surface 52 can be satisfactorily sealed by a resilient restoring force of the packing 50 compressed in this way.

That is, a large surface pressure may be generated between the tapered inner peripheral surface 13 and the tapered outer peripheral surface 52 to obtain good sealability. To generate the large surface pressure, it is thought to increase a crushing amount of the packing 50. In this embodiment, the crushing amount of the packing 50 can be increased by compressing the packing 50 in the insertion direction A and the direction intersecting the insertion direction A, whereby good sealability can be obtained.

Further, the packing 50 is compressed in the insertion direction A and the direction intersecting the insertion direction A and a repulsive force in the direction intersecting the insertion direction A is received by the inserting portion 32 and the terminals 22 in the inserting portion 32. Thus, a repulsive force received by the fixing portion 40 becomes smaller for a total crushing amount of the packing 50. In this way, the block body 30 hardly undergoes creep deformation and sealability by the packing 50 is maintained for a longer period of time.

Further, to suppress creep deformation, it is not necessary to add a reinforcement rib or a separate member made of metal to the block body 30. This enables a reduction in resin amount, a size reduction, a height reduction and a cost reduction.

Further, since a contact part of the attachment target 10 and the packing 50 is inclined with respect to the insertion direction A, an installation region of the packing 50 can be reduced in a plan view along the insertion direction A. In this way, the terminal block 20 and an installation space thereof can be reduced in size.

Further, the tapered outer peripheral surface 52 has the curved surfaces 53a, 53b convex outward in the cross-section along the insertion direction A. Thus, even if the terminal block 20 is inclined in a state mounted in the mounting hole 12, the curved surfaces 53a, 53b can stably contact the tapered inner peripheral surface 13 of the mounting hole 12 and good sealability is obtained.

Further, since the curved surfaces 53a1, 53a2 located on the sides opposite to each other in the packing 50 are located on the same virtual circumference C, the contact state of the curved surfaces 53a1, 53a2 with the tapered inner peripheral surface 13 of the mounting hole 12 is stable when the terminal block 20 is inclined.

Further, since the curved surface 53a includes the cylindrical part outer peripheral surface having the swing axis X of the block body 30 with respect to the attachment target 10 as the center of curvature, the cylindrical part outer peripheral surface can stably contact the inner peripheral surface of the mounting hole if the terminal block 20 swings around the swing axis X.

If the center of curvature of the cylindrical part outer peripheral surface of the curved surface 53a is located on the straight line L passing through the first and second fixing parts P1, P2 to the attachment target 10, the cylindrical part outer peripheral surface of the curved surface 53a can stably contact the tapered inner peripheral surface 13 of the mounting hole 12 if the terminal block 20 swings with the straight line L as the swing axis.

Further, the outer peripheral surface of the inserting portion 32 includes the pressing tapered outer peripheral surface 33 becoming gradually smaller in the insertion direction A, and the inner peripheral surface of the packing 50 includes the tapered inner peripheral surface 54 as a part shaped to become gradually smaller in the insertion direction A. Thus, the packing 50 is easily compressed in the direction intersecting the insertion direction A by pressing the pressing tapered outer peripheral surface 33 of the inserting portion 32 against the tapered inner peripheral surface 54 of the packing 50.

Further, the outer peripheral surface of the inserting portion 32 and the inner peripheral surface of the packing 50 include the end parts 34, 54 respectively continuous with the tip side in the insertion direction A of the pressing tapered outer peripheral surface 33 or the tapered inner peripheral surface 54 and continuously having the same shape along the insertion direction A. The outer end part 54a of the packing 50 tightens the end part of the inserting portion 32. In this way, the packing 50 is easily held not to be detached from the inserting portion 32.

Further, the packing 50 includes the plurality of annular ribs 55. Thus, the packing 50 can be resiliently deformed to crush the plurality of annular ribs 55 with the inserting portion 32 inserted in the mounting hole 12. In this way, dimensions of each component can be so designed that the packing 50 is sufficiently resiliently deformed in consideration of manufacturing errors or assembly errors. In this way, good sealability can be obtained, regardless of the manufacturing errors or assembly errors.

Further, if the curved surfaces 53a, 53b are smoother than the inner peripheral surface by the annular ribs 55, the packing 50 can be largely resiliently deformed by the plurality of annular ribs 55 on the inner periphery of the packing 50. If the curved surfaces 53a, 53b on the outer periphery of the packing 50 are formed to be smoother than the inner peripheral surface of the packing, the tapered outer peripheral surface 52 is easily brought into contact with the tapered inner peripheral surface 13 even if a partial recess is formed in the tapered inner peripheral surface 13 of the mounting hole 12.

For example, a partial recess may be more easily formed in the surface of the attachment target 10 than in the surface of the block body 30. For example, if the attachment target 10 is a casting made of metal, a casting nest is thought to be easily formed in the surface of the attachment target 10. As just described, even if a partial recess is formed in the inner peripheral surface of the mounting hole 12, the tapered outer peripheral surface 52 is easily brought into contact with the tapered inner peripheral surface 13 around that recess. In this way, sealability between the mounting hole 12 and the packing 50 can be improved in the entire mounting hole 12 in the circumferential direction.

Further, if the block body 30 includes the fixing portion 40 connected to the base end side of the inserting portion 32 and to be fastened and fixed to the attachment target 10 outside the inserting portion 32, the inserting portion 32 can be held in a state pushed in the mounting hole 12 by the fixing portion 40.

Further, since the packing 50 is in contact with the fixing portion 40, the packing 50 is easily pushed into the mounting hole 12 by the fixing portion 40.

### Modification

In this embodiment, the packing functions as a wedge and a force for compressing the packing in the direction intersecting the insertion direction can be generated as the packing is inserted into the mounting hole.

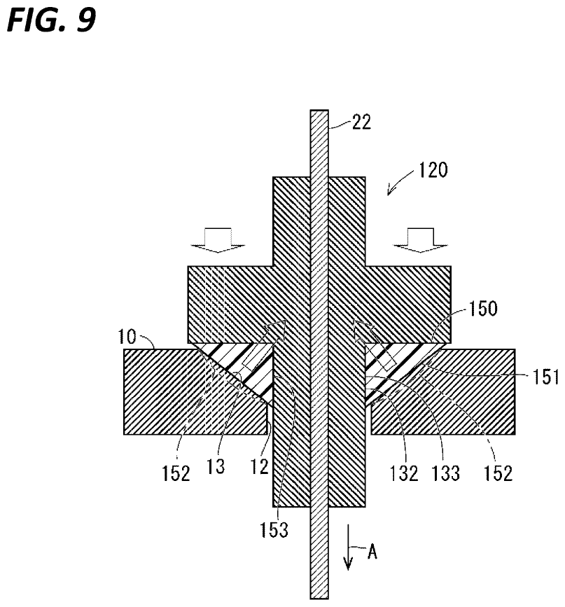

Thus, for example, like a terminal block 120 according to a modification shown in FIG. 9, an outer peripheral surface 151 of a packing 150 corresponding to the packing 50 may be a surface becoming gradually smaller in the insertion direction A and shaped to include curved surfaces 152 (initial state is shown by two-dot chain lines), and an outer peripheral surface 133 of an inserting portion 132 corresponding to the inserting portion 32 and an inner peripheral surface 153 of the packing 150 may be surfaces continuously having the same shape in the insertion direction A.

Also in a case shown in FIG. 9, the packing 150 is compressed in the direction intersecting the insertion direction A. A repulsive force due to this compression acts in the direction intersecting the insertion direction A and is received by the terminals 22. Further, even if the terminal block 120 is inclined, the curved surfaces 152 stably contact the mounting hole 12. Thus, as in the above embodiment, the terminal block 120 hardly undergoes creep deformation, sealability by the packing 150 can be maintained for a longer period of time and, even if the terminal block 120 is inclined, stable sealability is obtained.

Note that the respective configurations described in the above embodiment and modification can be appropriately combined without contradicting each other.

### LIST OF REFERENCE NUMERALS

10 attachment target
12 mounting hole
13 tapered inner peripheral surface
14 screw hole
15 guide hole
20, 120 terminal block
22 terminal
23 first end
24 second end
25 terminal intermediate portion
30 block body
32, 132 inserting portion
33 pressing tapered outer peripheral surface
34 end part
35 annular protrusion
36 first terminal holding portion
37 partition wall
38 second terminal holding portion
40 fixing portion
42 insertion hole
44 guide pin
50, 150 packing
51A long side portion
51B short side portion
52 tapered outer peripheral surface
53a, 53b, 152 curved surface
53a1 first curved surface
53a2 second curved surface
54 tapered inner peripheral surface
54a outer end part
55 annular rib
133 outer peripheral surface
151 outer peripheral surface
153 inner peripheral surface
A insertion direction
C virtual circumference
P1 first fixing part
P2 second fixing part
S screw
X swing axis

1. A terminal block to be fixed to an attachment target including a mounting hole, comprising:
a terminal including a first end, a second end and a terminal intermediate portion between the first end and the second end;
a block body including an inserting portion to be inserted into the mounting hole, the inserting portion being fixed to the attachment target while being inserted in the mounting hole; and
a packing to be interposed between the inserting portion and the mounting hole with the block body fixed to the attachment target,
the block body holding the terminal while covering the terminal intermediate portion,
an outer peripheral surface of the packing including a tapered outer peripheral surface becoming gradually smaller in an insertion direction into the mounting hole and the tapered outer peripheral surface including a curved surface convex outward in a cross-section along the insertion direction,
the curved surface including a first curved surface and a second curved surface located on a side opposite to the first curved surface,
each of the first curved surface and the second curved surface including a cylindrical part outer peripheral surface having a swing axis of the block body with respect to the attachment target as a center of curvature, and
the center of curvature of the cylindrical part outer peripheral surface of each of the first curved surface and the second curved surface being the same swing axis and a radius of curvature of the cylindrical part outer peripheral surface of each of the first curved surface and the second curved surface being equal.

2. The terminal block of claim 1, wherein:
the packing includes a pair of long side portions arranged in parallel at an interval and a pair of short side portions connecting both ends of the pair of long side portions,
a length of the packing in an extension direction of the pair of long side portions is larger than a width of the packing in a connection direction of the pair of long side portions, and
the curved surface is formed on an outward facing surface of each of the pair of long side portions.

3. (canceled)

4. (canceled)

5. The terminal block of claim 1, wherein the center of curvature of the cylindrical part outer peripheral surface is located on a straight line passing through a first fixing part and a second fixing part to the attachment target.

6. The terminal block of claim 1, wherein an outer peripheral surface of the inserting portion includes a pressing tapered outer peripheral surface becoming gradually smaller in the insertion direction.

7. The terminal block of claim 6, wherein:
the outer peripheral surface of the inserting portion includes an end part continuous with a tip side of the pressing tapered outer peripheral surface in the insertion direction and continuously having the same shape along the insertion direction,
an inner peripheral surface of the packing includes an outer end part continuously having the same shape along the insertion direction on an outer peripheral side of the end part, and
the outer end part of the packing tightens the end part by a resilient force thereof.

8. The terminal block of claim 1, wherein the packing includes a plurality of annular ribs extending along a circumferential direction on an inner peripheral side of the packing and arranged along the insertion direction.

9. The terminal block of claim 8, wherein the curved surface is smoother than an inner peripheral surface by the plurality of annular ribs.

10. The terminal block of claim 1, wherein the block body includes a fixing portion connected to a base end side of the inserting portion and to be fastened and fixed to the attachment target outside the inserting portion.
